(19) United States
(12) Patent Application Publication
(10) Pub. No.: US 2010/0205331 A1
(43) Pub. Date: Aug. 12, 2010

(54) Non-Volatile Memory That Includes An Internal Data Source

(76) Inventor: Xueshi Yang, Cupertino, CA (US)

Correspondence Address: FISH & RICHARDSON P.C., P.O BOX 1022, MINNEAPOLIS, MN, 55440-1022, US

(21) Appl. No.: 12/696,701

(22) Filed: Jan. 29, 2010

Related U.S. Application Data
(60) Provisional application No. 61/151,025, filed on Feb. 9, 2009.

(51) Int. Cl. G06F 13/00; G06F 12/00; G06F 12/02

(52) U.S. Cl. 710/53; 711/103; 711/E12.001; 711/E12.008

(57) ABSTRACT

The present disclosure includes systems and techniques relating to a non-volatile memory that includes an internal data source. In some implementations, a device includes a buffer, a memory cell array, and processing circuitry coupled with the buffer and the memory cell array, and configured to selectively fill the buffer with auxiliary data from the internal data source specified by the controller and user data received from an external source, in response to instructions from the controller.

### CROSS REFERENCE TO RELATED APPLICATIONS

This application claims the benefit of the priority of U.S. Provisional Application Ser. No. 61/151,025, filed Feb. 9, 2009 and entitled “Non-Volatile Memory Devices with Internal Program Data Source”.

### BACKGROUND

The present disclosure describes systems and techniques relating to non-volatile memory.

Devices and systems can store or retrieve data using non-volatile memory such as flash memory. For example, a digital camera can store an image to non-volatile memory. In another example, a digital media player such as an MP3 player can read a digital audio file from non-volatile memory and play the contents of the audio file. Mobile devices such as a mobile phone or a personal digital assistant (PDA) can read data from and write data to one or more non-volatile memory. Moreover, for various storage application (for example, using flash memory based storage devices) a user data sector is often stored in a page along with other auxiliary data such as meta data.

Devices and systems can perform multiple operations on non-volatile memory, such as reading and programming operations. Various types of programming operations can include writing and erasing data. Erasing data in such memory can include marking a data area as invalid or not programmed. Non-volatile memory such as flash memory can be divided into multiple data areas. Each data area can be individually addressed and accessed. Accordingly, an operation can include obtaining an address for one or more data areas or a portion of a data area. Also, a data area can be divided into individual bits or larger aggregate data units such as bytes. In some implementations, a data area can be arranged as a data page or a data block.

### SUMMARY

The present disclosure includes systems and techniques relating to a non-volatile memory that includes an internal data source. An innovative aspect of the described systems and techniques can be implemented as a device that includes a buffer configured to connect with a controller. The buffer is configured to hold data. A memory cell array is coupled to the buffer and is configured to store data transferred from the buffer. Processing circuitry is coupled with the buffer and the memory cell array. The processing circuitry is configured to selectively fill the buffer with auxiliary data specified by the controller.

This, and other aspects, can include one or more of the following features. The device can include an internal data source coupled to the buffer. The internal data source can be configured to generate the auxiliary data. The processing circuitry can be configured to cause the auxiliary data to be transferred to the buffer from the internal source.

Another innovative aspect of the described systems and techniques can be implemented as a method that includes directing a non-volatile memory to fill a buffer with auxiliary data in response to receiving an indication that the auxiliary data is to be transferred to the buffer. The auxiliary data is transferred to a memory cell array of the non-volatile memory to store the auxiliary.

This, and other aspects, can include one or more of the following features. The auxiliary data can be format data, and directing the non-volatile memory to fill the buffer with auxiliary data can include formatting the buffer with the auxiliary data. The auxiliary data can be obtained from an internal source located within the non-volatile memory. Directing the non-volatile memory to fill the buffer with auxiliary data can include providing an instruction to the internal data source to transfer the auxiliary data to the buffer.

The described systems and techniques can be implemented in electronic circuitry, computer hardware, firmware, software, or in combinations of them, such as the structural means disclosed in this specification and structural equivalents thereof. This can include at least one computer-readable medium embodying a program operable to cause one or more data processing apparatus (for example, a signal processing device including a programmable processor) to perform operations described. Thus, program implementations can be realized from a disclosed method, system, or apparatus, and apparatus implementations can be realized from a disclosed system, computer-readable medium, or method. Similarly, method implementations can be realized from a disclosed system, computer-readable medium, or apparatus, and system implementations can be realized from a disclosed method, computer-readable medium, or apparatus.

For example, the disclosed embodiment(s) below can be implemented in various systems and apparatus, including, but not limited to, a special purpose data processing apparatus (for example, a wireless access point, a remote environment monitor, a router, a switch, a computer system component, a medium access unit), a mobile data processing apparatus (for example, a wireless client, a mobile telephone, a personal digital assistant (PDA), a mobile computer, a digital camera), a general purpose data processing apparatus (for example, a minicomputer, a server, a mainframe, a supercomputer), or combinations of these.

Thus, according to another aspect of the described systems and techniques, a system can include a non-volatile memory including a memory cell array configured to store data, a buffer coupled to the memory cell array and configured to hold data, an internal data source coupled to the buffer and configured to provide auxiliary data to the buffer, and processing circuitry configured to transfer data between the memory cell array, the buffer, and the internal data source. The system includes a controller coupled to the non-volatile memory and configured to provide instructions to cause the processing circuitry to selectively fill the buffer with auxiliary data provided by the internal data source. The system includes an interface coupling the controller and the non-volatile memory through which the controller provides instructions to the processing circuitry.

The subject matter described in this specification can be implemented to realize one or more of the following potential advantages. A speed of data transfer to and from a memory cell array in a non-volatile memory can be increased, and a time of the data transfer can correspondingly be decreased. Decreasing the time of the transfer can increase data throughput and reduce power consumption by the non-volatile memory. For example, the process of testing the non-volatile memory by repeatedly writing data to and erasing data from the memory can be performed faster. In turn, this can reduce product qualification time, and can thereby increase production throughput. For example, when non-volatile memory devices are tested/qualified during manufacturing, the time necessary to transfer data through an input/output interface can be avoided by using internal data alone. Bandwidth limitations imposed on non-volatile memory due to limitations in data transfer rates can be overcome. Moreover, these improvements can be realized with minimal additional components and any corresponding additional costs.

Details of one or more implementations are set forth in the accompanying drawings and the description below. Other features, objects and advantages may be apparent from the description and drawings, and from the claims.

### DRAWING DESCRIPTIONS

FIG. 1 shows an example of a non-volatile memory controller connected between a computing system and a non-volatile memory.

FIG. 2 shows an example of a computing system including a solid state memory subsystem.

FIG. 3 shows an example of a flash memory architecture including an internal data source.

FIG. 4 shows an example of a process of filling a buffer with auxiliary data and user data.

### DETAILED DESCRIPTION

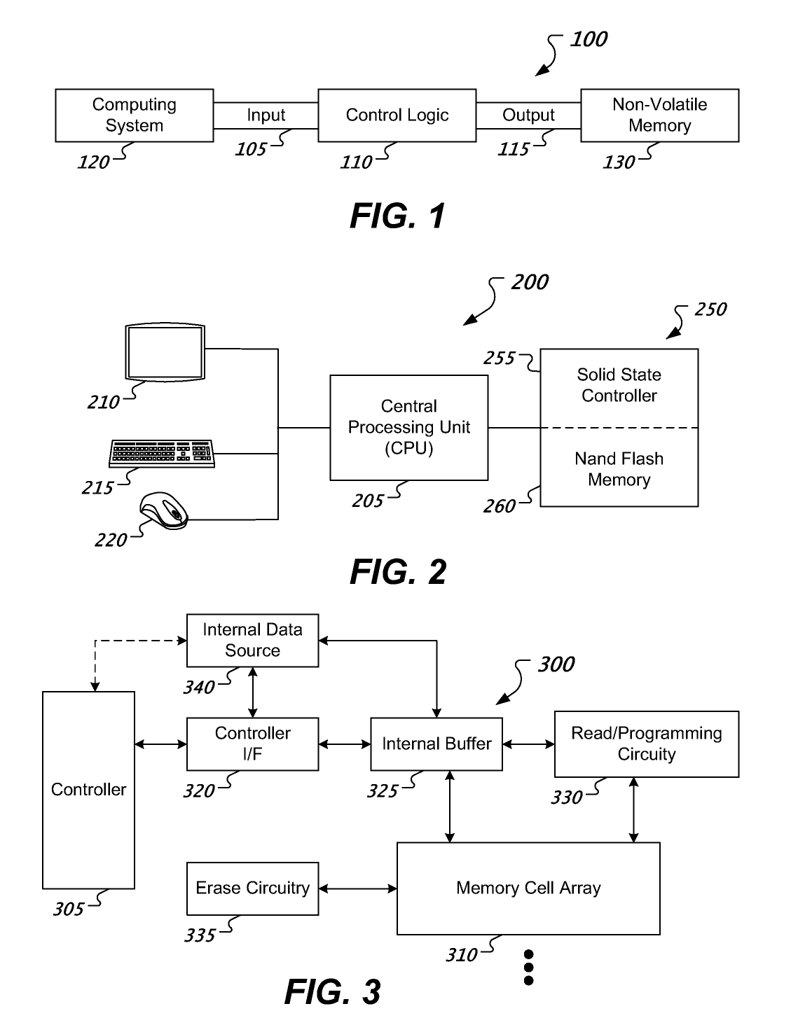

FIG. 1 shows an example of a non-volatile memory controller 100 connected between a computing system 120 and a non-volatile memory 130. The controller 100 includes an input 105 configured to connect with the computing system 120 (for example, a connector designed to attach to a motherboard of a personal computer), and an output 115 configured to connect with the non-volatile memory 130 (for example, a connector designed to attach to NAND flash memory or NOR flash memory). The controller 100 also includes control logic 110 configured to transfer instructions to the non-volatile memory 130, in response to which the non-volatile memory 130 transfers data to and receives data from an external source, such as a memory operatively coupled to (or within) the computing system 120.

A time taken by an operation performed on the non-volatile memory 130 that involves data transfer, for example, read and write, can depend on a rate at which the non-volatile memory 130 is configured to receive and transfer data between its individual components. For example, auxiliary data written either along with user data or by itself can either be of a particular data type that is received from the user or can be of some standard type that can be received from any source. This can be particularly true for program data that is used to format a buffer that stores the user data or data used to erase the buffer when repeatedly testing the non-volatile memory 130. By providing one or more internal program data sources that reside within a structure of the non-volatile memory 130, a speed of transfer of auxiliary data within the non-volatile memory 130 can be increased, thereby increasing data throughput and decreasing power consumption.

The control logic 110 can include application specific integrated circuitry, a programmable microprocessor, or both. These components represent the structures that can embody and implement the functionality described herein. Other components can also be included in the controller 100, such as a charge pump, a data buffer, a program code store, and the like. As will be appreciated, these various components can be implemented in one or more devices, such as one or more integrated circuit (IC) devices, including, for example, a NAND flash controller designed for use in both personal computers and mobile internet devices.

Moreover, such devices can be designed and manufactured to be readily installed in larger devices and systems, or designed and manufactured as integral components of such larger devices and systems. For example, the controller 100 can be part of a System-on-a-Chip (SoC) device, which can include processor(s), memory interface(s), and read-only and random access memories, as well as potentially other components. The non-volatile memory 130 can be external to the SoC, but the non-volatile memory 130 can nonetheless be combined with the SoC to form an integrated device. For example, the non-volatile memory 130 and SoC can be affixed to a printed circuit board. In some implementations, the non-volatile memory 130 is located within a removable structure that mechanically and electrically couples with another structure that houses the controller 100 (or that houses a SoC of which the controller 100 forms a part).

FIG. 2 shows an example of a computing system 200 including a solid state memory subsystem 250. The system 200 includes a central processing unit (CPU) 205, a display device 210 (for example, a CRT (cathode ray tube) or LCD (liquid crystal display) monitor), and an input device such as a keyboard 215, and a pointing device 220 (which although shown as a mouse device in FIG. 1, can be other pointing devices). The system 200 can include one or more additional processors and one or more additional input/output devices, for example, microphone, speakers, printer, etc.

The solid state memory subsystem 250 includes a solid state controller 255 and a NAND flash memory 260. The NAND flash memory 260 can be a single-level cell (SLC) devices or a multi-level cell (MLC) device. The solid state memory subsystem 250 can include control logic as described herein, which can be designed to allow the solid state memory subsystem 250 to load operating system and applications software into the system 200 more quickly.

As will be appreciated, the system 200 represents a desktop personal computer, which can include many other devices and subsystems that are not shown, such as a hard disk drive, a network interface, a motherboard, etc. However, this is only one example of a larger system in which the presently disclosed subject matter can be implemented. Other examples of such larger devices and systems include laptops, notebooks, diskless sub-notebooks, and ultra-slim drives that fit into a PCI ExpressCard, PCIeMini slot on a laptop or PCIe slot on a desktop, while appearing as just another drive. Examples also include smart phones, netbooks, media players, and the like, that employ non-volatile memory devices.

However, irrespective of these specific examples, it will be appreciated that the subject matter described herein can be made compatible with many different types of computing systems 120. In addition, the non-volatile memory 130 can include many different types of solid state storage devices that are able to maintain their data without any external source of power. Such devices can include flash memory devices, such as a BIOS chip, CompactFlash, SmartMedia, a memory stick, PCMCIA Type I and Type II memory cards, and memory cards for video game consoles. Such devices can also include phase change memory devices.

FIG. 3 shows an example of a flash memory architecture 300. A controller 305 connects with a controller interface 320 to manage the transfer of data from an external source into an internal buffer 325. The internal buffer 325 can be random access memory used as a temporary storage location before commencement of programming a memory cell array 310. Read/programming circuitry 330 can be used to write data from the internal buffer 325 to the memory cell array 310 and to read data out of the memory cell array 310. Erase circuitry 335 can be used to erase data from the memory cell array 310. In addition, as will be appreciated, more than one memory cell array 310, and additional data control/management circuitry, can be included in the flash memory architecture 300.

The data that is put into the internal buffer 325, before being programmed into the memory cell array 310, can be received from one or more external sources. The data to be programmed is of different types, each of which can have different characteristics. Examples of different types of data include user data, meta data (either external or controller specified), and auxiliary data that includes format data, nuisance data, and the like. Nuisance data can be data programmed into the memory but that does not affect or that is not affected by user data.

For example, when a flash memory device (any device incorporating the flash memory architecture 300) is manufactured, a memory block of the memory cell array 310 can be tested to verify that the block is working properly. If it is determined that the memory block is not working properly, then the block is marked as bad, for example, by an indicator bit marked in the device. The operations to verify the memory block include writing auxiliary data to the block and then verifying that the written auxiliary data is correct. In such situations, rather than transferring the auxiliary data that is to be written to the memory block through the controller interface 320 for each instance of verifying a memory block, the auxiliary data can be stored in an internal data source 340.

In some situations, when a page of data is received for storage, only part of the page to be programmed includes user data. The remainder of the page of data represents auxiliary data, such as, all “1”s, used to format the internal buffer 325. For example, a 4 KB page of data can include 2 KB of user data and 2 KB of auxiliary data, which is of a standard type and can be received from any source, not necessarily the same source as the user data. In some situations, only the 2 KB of user data may be received; the 2 KB of auxiliary data may not be received. In such situations, the auxiliary data needed to store the page of data can be obtained from the internal data source 340, described below.

An internal data source 340, that connects with the controller interface 320 and the internal buffer 325, provides the auxiliary data. Generally, a physical structure of a flash memory device contains the components of the flash memory architecture 300 except the controller 305. The controller 305 transfers instructions to control the flash memory device through an input included in the device. The flash memory device additionally includes processing circuitry that performs operations in response to the instructions provided by the controller 305. The controller 305 provides instructions to cause the processing circuitry to perform multiple operations including transferring auxiliary data from the internal data source 340 to the internal buffer 325.

The internal data source 340 is included within the physical structure of the flash memory device. The presence of the internal data source 340 within the physical structure of the device negates the need to transfer auxiliary data to the internal buffer 325 from a source external to the device. As described previously, this increases data throughput and decreases data transfer through the interface. The internal data source 340 need not be external to the physical structure of the internal buffer 325, as shown in FIG. 3, but rather can physically reside within the internal buffer 325. Alternatively, the internal data source 340 can physically reside external to the internal buffer 325, and transfer auxiliary data to the internal buffer 325. The controller 305 receives an indication to transfer user data to the internal buffer 325 and controls the internal data source 340 to transfer auxiliary data to the internal buffer 325, responsive to the indication.

The controller 325 can cause the internal data source 340 to transfer data to the internal buffer 325 either automatically or responsive to input. For example, a 4 KB page of data is to be stored in the memory cell array 310, 2 KB of which is user data. The remaining 2 KB is auxiliary data, which can be received from any source and not necessarily from the same source as the user data. In such a situation, the internal data source 340 is configured to provide the 2 KB of auxiliary data. In operation, the controller 305 transfers 2 KB of the page (the user data) to the internal buffer 325 through the controller interface 320. Then, the controller 305 receives input to store the page. In response to the input, the controller 305 causes the 2 KB of auxiliary data to be transferred from the internal data source 340 to the internal buffer 325. Subsequently, the controller 305 programs the page for storing, i.e., the controller 305 provides instructions to cause the processing circuitry to program the page for storing.

In another example, the auxiliary data is to be written to a memory block of the memory cell array 310. The controller 305 can populate the internal data source 340 with the auxiliary data. Specifically, the controller 305 can perform the task of transferring the auxiliary data from an external source to the internal data source 340 only once. Subsequently, the controller 305 can execute the actual programming, i.e., transfer the auxiliary data from the internal data source 340 to the memory block in the memory cell array 310 through the internal buffer 325. Because the auxiliary data is available in the internal data source 340, for testing other memory blocks in the memory cell array 310, auxiliary data need not be obtained from an external source.

A rate of data transfer between the internal data source 340 and the internal buffer 325 is greater than a rate of data transfer between the source of the user data or the external source of the auxiliary data and the internal buffer 325. Consequently, the auxiliary data is received faster from the internal data source 340 than from an external data source, thereby increasing data throughput. Further, in the first of the aforementioned examples, a quantity of data received from an external data source decreases from 4 KB (2 KB of user data +2 KB of auxiliary data) to 2 KB (2 KB of user data only). Therefore, a rate of data transfer to the internal buffer 325 is decreased.

In some situations, to repeatedly provide auxiliary data to the internal buffer 325, the controller 305 causes the internal data source 340 to automatically transfer auxiliary data to the internal buffer 325. In an operation in which user data is periodically transmitted to the internal buffer 325 through the controller interface 320, the controller 305 causes the auxiliary data of the internal data source 340 to also be periodically transmitted to the internal buffer, without providing input to the internal data source 340 for each instance of auxiliary data transfer. For example, the auxiliary data includes format data with which the internal buffer 325 is to be formatted prior to receiving the user data. The received user data is then transferred to the memory cell array 310, at which point, the internal buffer 325 is once again to be formatted with the auxiliary data. In such situations, the controller 305 causes the format data to be automatically transferred to the internal buffer 325.

As described previously, the controller interface 320 manages data transfer between an external source and the internal buffer 325. In some implementations, the controller 305 instructs the external source to transfer data through the controller interface 320 and into the internal buffer 325. The internal buffer 325 can then transfer the data to the memory cell array 310. In some scenarios, a rate of data transfer between the controller 305 and the internal buffer 325 can be less than a rate of data transfer between the internal buffer 325 and the memory cell array 310. This can be because data transfer between the controller 305 and the controller interface 320 is through serial data transfer, whereas data transfer between the internal buffer 325 and the memory cell array 310 is through parallel data transfer.

In some implementations, the internal data source 340 can be configured to transfer data to the internal buffer 325 through parallel data transfer, for example, a 64 bit or a 128 bit parallel data transfer. In such implementations, because the internal data source 340 provides the auxiliary data, user data alone can be received from the external source. Thus, the quantity of data that the internal buffer 325 receives from the external source decreases relative to the quantity that the internal buffer 325 would receive if both the user data and the auxiliary data were transferred by the external source. In addition, parallel data transfer from the internal data source 340 to the internal buffer 325 is faster than a rate at which the auxiliary data would be transferred were it received from a different source.

In some implementations, a serial bus, that connects the external source and the internal buffer 325 and is controlled by the controller 305, can transfer data between the external source and the controller interface 320 at a rate of 8 bits per unit time. A clock can periodically transfer the data through the serial bus. For example, the internal buffer 325 can be reset to all “0”s in parallel. In another example, the internal buffer 325 is connected to a page of flash cells having the same size as the internal buffer 325. In this example, each bit in the internal buffer 325 can correspond to and can be connected to a flash cell. Transfer can be realized by reading the page of flash cells and transferring the data to the internal buffer 325.

As will be appreciated, serial data transfer between the external device and the controller interface 320 and parallel data transfer between the internal data source 340 and the internal buffer 325 are not the only scenarios under which the internal data source 340 is applied. Rather, the internal data source 340 can be used for application in any scenario in which a rate of data transfer between the internal data source 340 and the internal buffer 325 is greater than that between the external source operated by the controller and the controller interface 320. For example, the internal data source 340 is used in a scenario in which data transfer between the external source and the controller interface 320 is through a combination of serial and parallel data transfer. In such situations, the internal data source 340 is used when, regardless of the method of data transfer, a rate of data transfer by the combination of serial and parallel data transfer is slower than a rate of data transfer between the internal data source 340 and the internal buffer 325. In some scenarios, the internal data source 340 can be used when doing so decreases power required to transfer data.

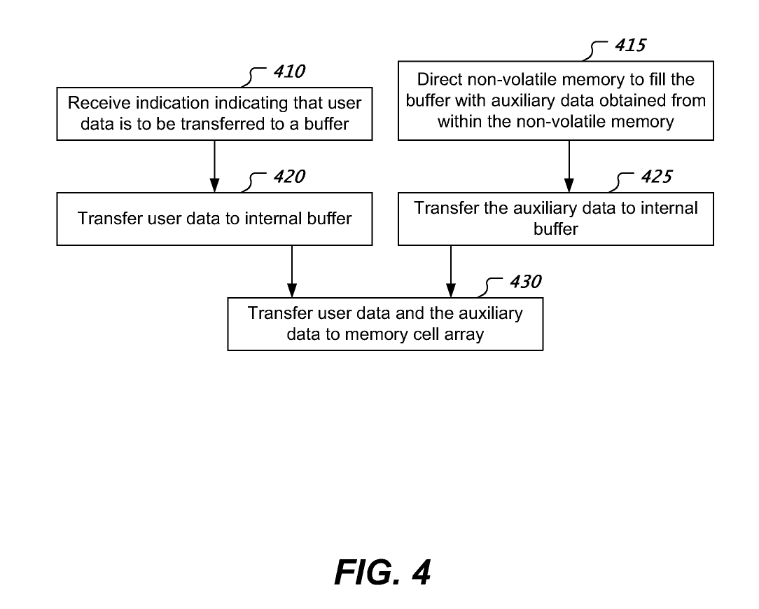

FIG. 4 shows an example of a process of filling a buffer with auxiliary data and user data. At 410, an indication that user data is to be transferred to a buffer in a non-volatile memory is received. This can involve receiving the user data from an external source, receiving an indication that the user data is available, or a combination of both.

At 415, user data can be transferred to the internal buffer. To do so, for example, the user data can be selectively transferred through the controller interface 320 to the internal buffer 325 through serial data transfer.

At 420, a direction to the non-volatile memory to fill the buffer with auxiliary data obtained from within the non-volatile memory can be provided. For example, the controller 305 can cause an external source to transfer the auxiliary data to the internal data source 340, and to store the auxiliary data. Alternatively, the internal data source 340 can be configured such that, in response to receiving a direction from the controller 305, the internal data source 340 generates the auxiliary data.

At 425, the auxiliary data can be transferred to the internal buffer 325. For example, the controller 305 can cause the auxiliary data to be transferred from the internal data source 340 to the internal buffer 325 through parallel data transfer. The processes of receiving user data and transferring the user data to the internal buffer 325 to selectively fill the internal buffer 325 and those of storing and transferring auxiliary data to the internal buffer 325 need not be performed in any particular sequence. For example, the controller 305 can store the auxiliary data in the internal data source 340. Then, the controller 305 can receive and transfer the user data to the internal buffer 325. Subsequently, the controller 305 can transfer the auxiliary data to the internal buffer 325. In an alternative sequence, the controller 305 can concurrently transfer the user data and the auxiliary data to the internal buffer 325.

In some implementations, auxiliary data need not be stored in the internal data source 340. Instead, the internal buffer 325 can be initialized with bits of a particular pattern, for example, all “1”s, all “0”s, alternating “1”s and “0”s, and the like. For example, subsequent to transferring the user data and the auxiliary data to the memory cell array, the controller 305 can initialize all bits in the internal buffer 325 with the particular pattern. As described previously, the controller 305 can perform the aforementioned processes by providing instructions to the processing circuitry, which, in response, executes the instructions, thereby causing the processes to be performed.

At 430, the user data and the auxiliary data can be transferred to the memory cell array. The aforementioned processes can be repeatedly performed to increase the data throughput and decrease data transfer requirements. In some situations, multiple copies of a page of data may need to be stored in the memory cell array 310. For example, the page of data has a total of 4 KB of data, of which 2 KB is user data and 2 KB is auxiliary data, such as, nuisance data. In such situations, the controller 305 can transfer the nuisance data from an external source to the internal data source 340 only once. Subsequently, for each instance of copying, the controller 305 can cause the transfer of only the 2 KB of user data from an external source through the controller interface 320 to the internal buffer 325. The controller 305 can cause the internal data source 340 to provide the remaining 2 KB of nuisance data.

It will be appreciated that in some situations only auxiliary data, and no user data, need be transferred to the memory cell array 310. As described previously, the memory cell array 310 can be tested by writing data to blocks of the array 310 and verifying the written data. In such situations, the portions of the process shown in FIG. 4 that describe transferring user data to the internal buffer need not be performed. In some situations, the memory cell array 310 can be tested by repeatedly writing data to and erasing data from the memory cell array 310. In such situations, after each instance of transferring data from the internal buffer 325 to the memory cell array 310, the internal buffer 325 can be initialized by the internal data source 340. Because the initial buffer 305 need not receive data, for example, “0”s, from an external source through the controller interface 320 by serial data transfer, a speed at which the data is written can be increased.

As described previously, the controller 305 can obtain auxiliary data from an external source. For example, the auxiliary data is stored in the memory cell array 310. In this example, the controller 305 can initiate a read operation on a page or block of data stored in the memory cell array 310, and store the results of the read operation in the internal buffer 325. The controller 305 can then make the data available to the internal source 340.

Alternatively, as described previously, the controller 305 can generate the auxiliary data at the internal data source 340, for example, all “1”s, and transfer the generated auxiliary data to the internal buffer 325. In some implementations, the controller 305 can issue a command to the internal data source 340 through the controller interface 320 to select a format of the auxiliary data. For example, the command can instruct the internal data source 340 to generate all “1”s or all “0”s or alternating “1”s and “0”s.

In some implementations, the internal buffer 325 can have a functionality of self-formatting. For example, the controller 305 can initiate a “format-0” command to the internal buffer 325. In response to the command, all the data in the internal buffer can be reset to 0.

In some implementations, the controller 305 can always initialize the internal buffer 325 to a known state, for example, all “1”s, before an operation involving the internal buffer 325 is to be performed. In this manner, the controller 305 can cause the internal buffer 325 to self-reset.

A few embodiments have been described in detail above, and various modifications are possible.

The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the operations described (such as a program encoded in a computer-readable medium, which can be a memory device, a storage device, a machine-readable storage substrate, or other physical, machine-readable medium, or a combination of one or more of them).

While this disclosure contains many specifics, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Other embodiments fall within the scope of the following claims.

What is claimed is:

1. A device comprising:
a buffer configured to connect with a controller, and configured to hold data;
a memory cell array coupled to the buffer and configured to store data transferred from the buffer; and
processing circuitry coupled with the buffer and the memory cell array, and configured to fill the buffer with auxiliary data specified by the controller.

2. The device of claim 1, wherein the processing circuitry is further configured to selectively fill the buffer with user data received from an external source.

3. The device of claim 1, further comprising an internal data source coupled to the buffer, the internal data source configured to generate the auxiliary data.

4. The device of claim 3, wherein the processing circuitry is configured to cause the auxiliary data to be transferred to the buffer from the internal data source.

5. The device of claim 3, wherein the controller is configured to receive input indicating that the user data is to be received at the buffer and to provide instructions to the processing circuitry to fill the buffer with the auxiliary data, and the processing circuitry is configured to fill the buffer with the auxiliary data.

6. The device of claim 3, wherein the processing circuitry is configured to transfer the auxiliary data to the internal data source.

7. The device of claim 2, wherein the processing circuitry is configured to fill the buffer with the auxiliary data and the user data by filling the buffer with the auxiliary data before filling the buffer with the user data.

8. The device of claim 1, wherein the processing circuitry is configured to transfer the auxiliary data to a non-volatile memory.

9. A method comprising:
directing, by processing circuitry, a non-volatile memory to fill a buffer with auxiliary data, in response to receiving an indication that the auxiliary data is to be transferred to the buffer; and
transferring the auxiliary data to a memory cell array of the non-volatile memory to store the auxiliary data.

10. The method of claim 9, further comprising:
receiving, by the processing circuitry, an indication that user data is to be transferred to the buffer in the non-volatile memory; and
transferring, by the processing circuitry, the user data to the buffer to selectively fill the buffer with the user data.

11. The method of claim 9, further comprising transferring the auxiliary data to the buffer through parallel data transfer, wherein user data is transferred to the buffer through serial data transfer.

12. The method of claim 9, further comprising transferring the auxiliary data to the buffer before transferring user data to selectively fill the buffer with the user data.

13. The method of claim 9, wherein the auxiliary data is format data, and wherein directing the non-volatile memory to fill the buffer with auxiliary data includes formatting the buffer with the auxiliary data.

14. The method of claim 9, further comprising receiving input indicating that the buffer has been filled with the auxiliary data, and responsive to the input, transferring user data to selectively fill the buffer.

15. The method of claim 9, wherein the auxiliary data is obtained from an internal data source located within the non-volatile memory, and wherein directing the non-volatile memory to fill the buffer with the auxiliary data includes providing an instruction to the internal data source to transfer the auxiliary data to the buffer.

16. A system comprising:
a non-volatile memory comprising:
a memory cell array configured to store data,
a buffer coupled to the memory cell array and configured to hold data,
an internal data source coupled to the buffer and configured to provide auxiliary data to the buffer, and
processing circuitry configured to transfer data between the memory cell array, the buffer, and the internal data source;
a controller coupled to the non-volatile memory and configured to provide instructions to cause the processing circuitry to fill the buffer with auxiliary data provided by the internal data source; and
an interface coupling the controller and the non-volatile memory through which the controller provides instructions to the processing circuitry.

17. The system of claim 16, wherein the controller is configured to provide instructions to cause the processing circuitry to selectively fill the buffer with user data, and wherein the controller transfers user data to the buffer through the interface.

18. The system of claim 17, wherein the controller fills the buffer with the auxiliary data before filling the buffer with the user data, and wherein the controller formats the buffer with the auxiliary data before filling the buffer with the user data.

19. The system of claim 16, wherein the controller fills the buffer with the auxiliary data after determining that the user data is transferred from the buffer and before receiving new user data at the buffer.

20. The system of claim 16, wherein the controller fills the buffer with the auxiliary data through parallel data transfer after filling the buffer with user data through serial data transfer.
